(19) United States
(12) Patent Application Publication
(10) Pub. No.: US 2019/0061216 A1
(43) Pub. Date: Feb. 28, 2019

(54) RUBBER INJECTION MOLD

(71) Applicant: UNION-TECH (QING YUAN) MOLD MANUFACTURING CO., LTD., Qingyuan City (CN)

(72) Inventor: Rongwu CHANG, Qingyuan City (CN)

(21) Appl. No.: 15/832,545

(22) Filed: Dec. 5, 2017

(30) Foreign Application Priority Data
Aug. 30, 2017 (CN) 201710765455.6

(51) Int. Cl. B29C 45/17; B29C 45/00; B29C 45/26

(52) U.S. Cl. CPC B29C 45/1771; B29C 45/0017; C08L 21/00; B29C 45/26; B29C 45/0053

(57) ABSTRACT

Rubber injection molds are provided. A rubber injection mold includes a binary form-stripping mold, a trinary form-stripping mold, and a quadruple form-stripping mold. The binary form-stripping mold can include an upper mold and a bottom mold movably connected to each other via a guide post. The trinary form-stripping mold can include an upper mold, a bottom mold, and a middle plate positioned between the upper mold and the bottom mold. The upper mold and the bottom mold movably connected to each other via a guide post welded to the bottom mold. The quadruple form-stripping mold can include an upper mold, a bottom mold, a middle plate, and a middle frame. A guide post is welded to the bottom mold. Side rails can be respectively arranged at two ends of the upper mold and the bottom mold. Upper mold handles are fixedly mounted in the side rails of the upper mold.

### TECHNICAL FIELD

The present disclosure relates to technical field of rubber molds, and more particularly, to a rubber injection mold.

### BACKGROUND

The production process of conventional rubber mold is as follows: a bottom mold is cast and machined by planning and milling; the manual mold assembly is completed; cut-off knives are utilized to cut materials by a bottom plant according to the shape of a bottom design of a single mold body, and the materials are put into a mold manually for hot press molding; and then the mold is trimmed and packaged by a finishing group. Herein, the process is troublesome, the productivity is low and the production cost is high.

### SUMMARY

The present disclosure aims to provide a rubber injection mold so as to solve the problems that the existing process is troublesome, the productivity is low and the production cost is high in the related art.

To this end, the following technical solutions are provided by the present disclosure: a rubber injection mold, including a binary form-stripping mold; the binary form-stripping mold consists of an upper mold and a bottom mold; the upper mold and the bottom mold are movably connected to one another via a guide post; the guide post is welded on the bottom mold; side rails are further respectively arranged at two ends of the upper mold and the bottom mold; upper mold handles are fixedly mounted in the side rails of the upper mold; an end of the upper mold handles is fixed to inner walls of the side rails, and other end of the upper mold handles is extended out of an external portion of the upper mold; front and rear rails are respectively, fixedly mounted on a lower surface of the upper mold and an upper surface of the bottom mold; the front and rear rails are fitted with each other; finished areas are further respectively arranged on a middle portion of the lower surface of the upper mold and the upper surface of the bottom mold; edge-tearing grooves are formed at a periphery of the finished area, surrounding the entire finished area; a sidewall flash groove is further formed on an outer wall at one side of the binary form-stripping mold; an inward of the sidewall flash groove is connected to an upper mold flow channel which is formed on an outer wall at one side of the upper mold.

As a further solution of the present disclosure, a sidewall edge-tearing groove is further formed on an outer wall joint of the bottom mold, adjoining the upper mold.

As a further solution of the present disclosure, lower-mold-locking briquettings are further respectively, fixedly mounted at two ends of the bottom mold.

As a further solution of the present disclosure, a tapered feeding hole is further formed on an upper surface of the upper mold, and connected to the finished areas.

Compared to the prior art, the present disclosure has the following beneficial effects.

According to the rubber injection mold of the present disclosure, the mold is made of steel and all components thereof are formed by reverse molding, so compared to the previous A3 iron, it is more precise and durable. Compared to the conventional mold that needs to utilize the cut-off knives one by one to cut the materials and needs manual displacement and hot press molding, the present injection manner is an automatic feeding production, so the feeding amount can be accurately controlled, and the material waste and the labor are reduced; and for a finished product after being molded by hot press molding and then being demolded, the burrs can be directly torn down by hand and thus the required outfits of the finishing group are reduced.

### BRIEF DESCRIPTION OF THE DRAWINGS

FIG. 1 is a schematic diagram of an entire structure of a binary form-stripping mold of the present disclosure;

FIG. 2 is a top view of a bottom mold of the binary form-stripping mold of the present disclosure;

FIG. 3 is a top view of an upper mold of the binary form-stripping mold of the present disclosure;

FIG. 4 is a transverse cross-section view of the binary form-stripping mold of the present disclosure;

FIG. 5 is a partial enlarged schematic diagram of an A-A section of the present disclosure;

FIG. 6 is a structural schematic diagram of a trinary form-stripping mold of the present disclosure;

FIG. 7 is a top view of a middle plate of the trinary form-stripping mold of the present disclosure;

FIG. 8 is a schematic diagram of an entire structure of a quadruple form-stripping mold of the present disclosure;

FIG. 9 is a top view of a middle frame of the quadruple form-stripping mold of the present disclosure;

FIG. 10 is a cross-section view of the quadruple form-stripping mold of the present disclosure; and

FIG. 11 is a partial enlarged schematic diagram of a B-B section of the present disclosure.

In the drawings: 1—binary form-stripping mold; 2—upper mold; 3—bottom mold; 31—guide post; 4—side rail; 5—upper mold handle; 6—front and rear rails; 7—finished area; 8—edge-tearing groove; 9—sidewall flash groove; 10—upper mold flow channel; 11—sidewall edge-tearing groove; 12—lower-mold-locking briquettings; 13—trinary form-stripping mold; 14—middle plate; 15—middle plate handle; 16—quadruple form-stripping mold; 17—middle frame; 18—middle frame handle; 19—lower mold flow channel; 20—rear button.

### DETAILED DESCRIPTION

The following clearly and completely describes the technical solutions in the embodiments of the present disclosure with reference to the accompanied drawings in the embodiments of the present disclosure. Apparently, the described embodiments are a part rather than all of the embodiments of the present disclosure. All other embodiments obtained by the skilled in the art based on the embodiments of the present disclosure without creative efforts shall fall within the protection scope of the present disclosure.

Embodiment 1:

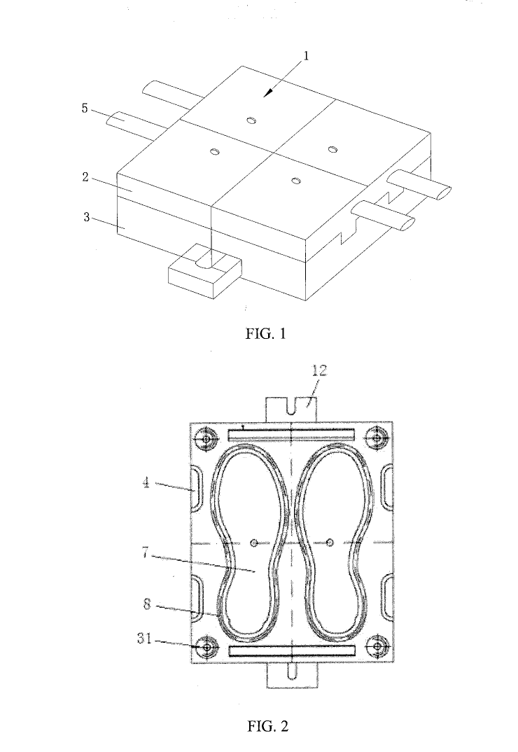

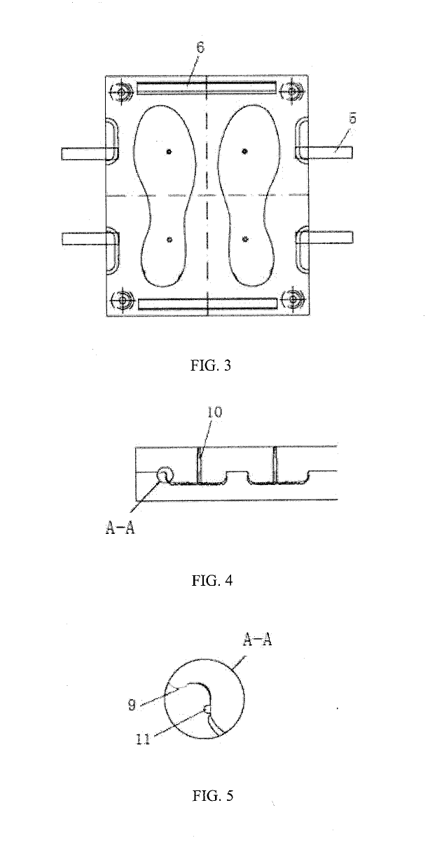

Referred to FIGS. 1-5, in an embodiment of the present disclosure, a rubber injection mold includes a binary form-stripping mold 1; the binary form-stripping mold 1 consists of an upper mold 2 and a bottom mold 3; the upper mold 2 and the bottom mold 3 are movably connected to each other via a guide post 31; the guide post 31 is welded on the bottom mold 3; a tapered feeding hole is further formed on an upper surface of the upper mold 2, and connected to finished areas 7, such that the color-matching production at a single color, two colors and more is achieved; side rails 4 are further respectively arranged at two ends of the upper mold 2 and the bottom mold 3; upper mold handles 5 are fixedly mounted in the side rails 4 of the upper mold 2; an end of the upper mold handles 5 is fixed to inner walls of the side rails 4, and other end of the upper mold handles 5 is extended out of an external portion of the upper mold 2; front and rear rails 6 are fixedly mounted on a lower surface of the upper mold 2 and an upper surface of the bottom mold 3 respectively; the front and rear rails 6 are fitted with each other; by means of the front and rear rails 6, the materials are prevented from being squeezed to overflow; the finished areas 7 are further arranged on an interface of the lower surface of the upper mold 2 and the upper surface of the bottom mold 3 respectively; edge-tearing grooves 8 are formed at a periphery of the finished areas 7, surrounding the entire finished areas 7; a sidewall flash groove 9 is further formed on an outer wall at one side of the binary form-stripping mold 1; an inward of the sidewall flash groove 9 is connected to an upper mold flow channel 10 which is formed on an outer wall at one side of the upper mold 2; a sidewall edge-tearing groove 11 is further formed on an outer wall joint of the bottom mold 3, adjoining the upper mold 2; lower-mold-locking briquettings 12 are further fixedly mounted at two ends of the bottom mold 3 respectively.

Embodiment 2:

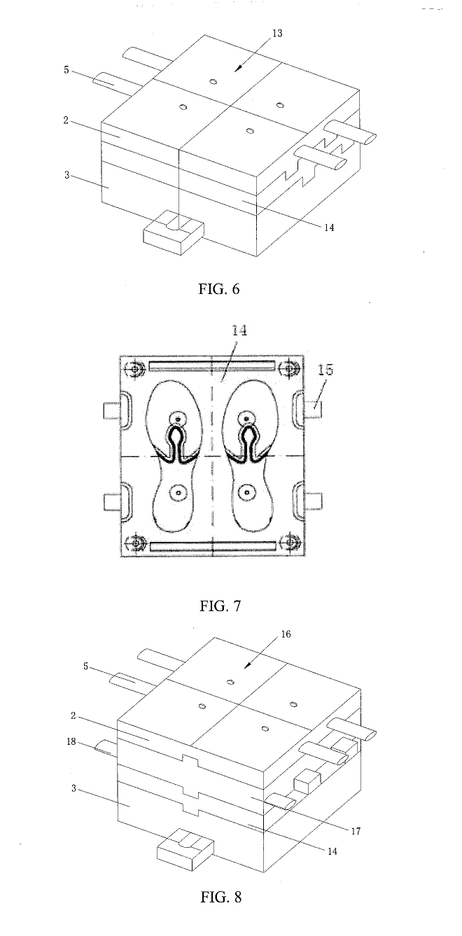

Referred to FIGS. 6-7, in an embodiment of the present disclosure, a rubber injection mold includes a trinary form-stripping mold 13. The trinary form-stripping mold 13 consists of an upper mold 2, a bottom mold 3 and a middle plate 14; the middle plate 14 is positioned between the upper mold 2 and the bottom mold 3; the upper mold 2 and the bottom mold 3 are movably connected to each other via a guide post 31; the guide post 31 is welded on the bottom mold 3; side rails 4 are further arranged at two ends of the upper mold 2 and the bottom mold 3 respectively; upper mold handles 5 are fixedly mounted in the side rails 4 of the upper mold 2; an end of the upper mold handles 5 is fixed to inner walls of the side rails 4, and other end of the upper mold handles 5 is extended out of an external portion of the upper mold 2; front and rear rails 5 are fixedly mounted on a lower surface of the upper mold 2 and an upper surface of the bottom mold 3 respectively; the front and rear rails 5 are fitted with each other; by means of the front and rear rails 5, the materials are prevented from being squeezed to overflow; a finished areas 7 are further arranged on an interface of the lower surface of the upper mold 2, the upper surface of the bottom mold 3 and a middle portion of the middle plate 14 respectively; edge-tearing grooves 8 are formed at a periphery of the finished areas 7, surrounding the entire finished areas 7; a sidewall flash groove 9 is further formed on an outer wall at one side of a trinary from-stripping mold 13; an inward of the sidewall flash groove 9 is connected to an upper mold flow channel 10 which 10 is formed on an outer wall at one side of the upper mold 2; a sidewall edge-tearing groove 11 is further formed at an outer wall joint of the bottom mold 3, adjoining the upper mold 2; lower-mold-locking briquettings 12 are further fixedly mounted at two ends of the bottom mold 3 respectively; middle plate handles 15 are further fixedly mounted on an outer surface of the middle plate 14; and four middle plate handles 15 are provided in total and are fixedly mounted on outer surfaces at the both ends of the middle plate 14 by taking two as a group.

Embodiment 3:

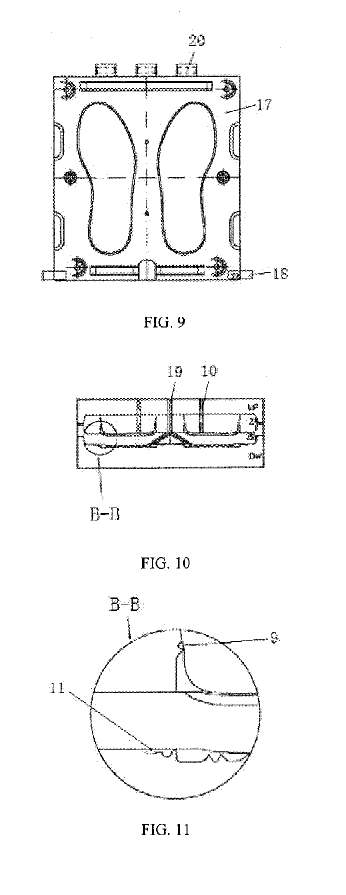

Referred to FIGS. 8-11, in an embodiment of the present disclosure, a rubber injection mold includes a quadruple form-stripping mold 16; the quadruple form-stripping mold 16 consists of an upper mold 2, a bottom mold 3, a middle plate 14 and a middle frame 17; the middle plate 14 is connected to the middle frame 17 in an embedding manner and is positioned between the upper mold 2 and the bottom mold 3; the upper mold 2 and the bottom mold 3 are movably connected to each other via a guide post 31; the guide post 31 is welded on the bottom mold 3; side rails 4 are further arranged at two ends of the upper mold 2 and the bottom mold 3 respectively; upper mold handles 5 are fixedly mounted in the side rails 4 of the upper mold 2; an end of the upper mold handles 5 is fixed to inner walls of the side rails 4, and other end of the upper mold handles 5 is extended out of an external portion of the upper mold 2; front and rear rails 5 are fixedly mounted on a lower surface of the upper mold 2 and an upper surface of the bottom mold 3 respectively; the front and rear rails 5 are fitted with each other; by means of the front and rear rails 5, the materials are prevented from being squeezed to overflow; finished areas 7 are further arranged on an interface of the lower surface of the upper mold 2, the upper surface of the bottom mold 3, and a middle portion of the middle plate 14 and the middle frame 17 respectively; edge-tearing grooves 8 are formed at a periphery of the finished areas 7, surrounding the entire finished areas 7; a sidewall flash groove 9 is further formed on an outer wall at one side of a quadruple form-stripping mold 16; an inward of the sidewall flash groove 9 is connected to an upper mold flow channel 10 and a lower mold flow channel 19 both of which are formed on an outer wall at one side of the upper mold 2; a sidewall edge-tearing groove 11 is further formed at an outer wall joint of the bottom mold 3, adjoining the upper mold 2; lower-mold-locking briquettings 12 are further fixedly mounted at two ends of the bottom mold 3 respectively; middle plate handles 15 are further fixedly mounted on an outer surface of the middle plate 14; four middle plate handles 15 are provided in total and are fixedly mounted on outer surfaces at the both ends of the middle plate 14 by taking two as a group; middle frame handles 18 are further fixedly mounted on an outer surface of the middle frame 17; two middle frame handles 18 are provided in total, and are fixedly mounted on outer surfaces at both ends of the middle frame 17 respectively; rear buttons 20 are further fixedly mounted on an outer wall of the middle frame 17; three rear buttons 20 are provided in total, and are fixedly mounted on the outer wall at one side of the middle frame 17 in parallel.

According to the rubber injection mold of the present disclosure, the mold is made of steel and all components thereof are formed by reverse molding. Compared to the previous A3 iron, the rubber injection mold is more precise and durable. Compared to the conventional mold that needs to utilize the cut-off knives one by one to cut the materials and needs manual displacement and hot press molding, the present injection manner is an automatic feeding production, so the feeding amount can be accurately controlled, and the material waste and the labor are reduced. For a finished product after being molded by the hot press molding and being demolded, the burrs can be directly torn down manually and thus the required outfits of the finishing group are reduced.

In conclusion, according to the rubber injection mold of the present disclosure, the feeding amount can be more accurately controlled and the waste is reduced; moreover, a cut-off knife is not required to be utilized to cut the materials for the hot press molding, so the trimming process of the finishing group is saved, the production cost is greatly reduced and the efficiency is higher; and the problems that the existing process is troublesome, the productivity is low and the production cost is high, are effectively solved.

For those skilled in the art, it is apparent that the present disclosure is not limited to the details of the above exemplary embodiments, and the present disclosure can be implemented by the way of other embodiments without departing from the spirit or basic features of the present disclosure. Therefore, in any way, the embodiments shall be regarded as exemplary rather than limiting; the scope of the present disclosure is defined by the appended claims, instead of the above description. Thus, all variations which fall into the meaning and scope of equivalent units of the claims shall be within the present disclosure. No reference numerals in the claims shall be regarded as limiting the involved claims.

In addition, it should be understood that the specification is described according to implementations, but not every implementation only includes an independent technical solution therein. Such description manner in the specification is merely for clarity. A person skilled in the art should take the specification as a whole, and the technical solutions in each embodiment may be combined as appropriate to form other implementations that may be understood by a person skilled in the art.

What is claimed is:

1. A rubber injection mold, comprising:
a binary form-stripping mold, wherein the binary form-stripping mold includes an upper mold, and a bottom mold;
the upper mold and the bottom mold are movably connected to each other via a guide post;
the guide post is welded on the bottom mold;
side rails are arranged at respective two ends of the upper mold and the bottom mold;
upper mold handles are fixedly mounted in the side rails of the upper mold;
an end of the upper mold handles is fixed to inner walls of the side rails, and another end of the upper mold handles is extended out of an external portion of the upper mold;
a front rail and a rear rail are respectively fixedly mounted on a lower surface of the upper mold and an upper surface of the bottom mold;
the front rail and the rear rail are fitted with each other;
finished areas are respectively arranged on a middle portion of the lower surface of the upper mold and the upper surface of the bottom mold;
edge-tearing grooves are formed at a periphery of the finished areas, surrounding the entire finished areas;
a sidewall flash groove is formed on an outer wall at one side of the binary form-stripping mold; and
an inward of the sidewall flash groove is connected to an upper mold flow channel which is formed on an outer wall at one side of the upper mold.

2. A rubber injection mold, comprising:
a trinary form-stripping mold, wherein the trinary form-stripping mold includes an upper mold, a bottom mold, and a middle plate;
the middle plate is positioned between the upper mold and the bottom mold;
the upper mold and the bottom mold are movably connected to each other via a guide post;
the guide post is welded to the bottom mold;
side rails are respectively arranged at two ends of the upper mold and the bottom mold;
upper mold handles are fixedly mounted in the side rails of the upper mold;
an end of the upper mold handles is fixed to inner walls of the side rails, and another end of the upper mold handles is extended out of an external portion of the upper mold;
a front rail and a rear rail are respectively fixedly mounted on a lower surface of the upper mold and an upper surface of the bottom mold;
finished areas are respectively arranged on an interface of the lower surface of the upper mold, the upper surface of the bottom mold and a middle portion of the middle plate;
edge-tearing grooves are formed at a periphery of the finished areas, surrounding the entire finished areas;
a sidewall flash groove is formed on an outer wall at one side of the trinary form-stripping mold;
an inward of the sidewall flash groove is connected to an upper mold runner;
the upper mold flow channel is formed on an outer wall at one side of the upper mold;
a sidewall edge-tearing groove is formed at an outer wall joint of the bottom mold, adjoining the upper mold;
lower-mold-locking briquettings are respectively fixedly mounted at two ends of the bottom mold;
middle plate handles are fixedly mounted on an outer surface of the middle plate; and
four middle plate handles are fixedly mounted on outer surfaces at both ends of the middle plate by taking two as a group.

3. A rubber injection mold, comprising:
a quadruple form-stripping mold, wherein the quadruple form-stripping mold includes an upper mold, a bottom mold, a middle plate, and a middle frame;
the middle plate is connected to the middle frame in an embedding manner and is positioned between the upper mold and the bottom mold;
the upper mold and the bottom mold are movably connected to each other via a guide post;
the guide post is welded to the bottom mold;
side rails are respectively arranged at two ends of the upper mold and the bottom mold;
upper mold handles are fixedly mounted in the side rails of the upper mold;
an end of the upper mold handles is fixed to inner walls of the side rails, and another end of the upper mold handles is extended out of an external portion of the upper mold;
a front rail and a rear rail are fixedly mounted on a lower surface of the upper mold and an upper surface of the bottom mold respectively;
the front rail and the rear rail are fitted with each other;
by means of the front rail and the rear rail, materials are prevented from being squeezed to overflow;
finished areas are respectively arranged on an interface of the lower surface of the upper mold, the upper surface of the bottom mold, and a middle portion of the middle plate, and the middle frame;
edge-tearing grooves are formed at a periphery of the finished areas, surrounding the entire finished areas;
a sidewall flash groove is formed on an outer wall at one side of a quadruple form-stripping mold;
an inward of the sidewall flash groove is connected to an upper mold flow channel and a lower mold flow channel;
the upper mold flow channel and the lower mold flow channel formed on an outer wall at one side of the upper mold;
a sidewall edge-tearing groove formed at an outer wall joint of the bottom mold, adjoining the upper mold;
lower-mold-locking briquettings respectively fixedly mounted at two ends of the bottom mold;
middle plate handles fixedly mounted on an outer surface of the middle plate;
four middle plate handles fixedly mounted on outer surfaces at the both ends of the middle plate by taking two as a group;
middle frame handles fixedly mounted on an outer surface of the middle frame;
two middle frame handles fixedly mounted on outer surfaces at both ends of the middle frame respectively;
rear buttons fixedly mounted on an outer wall of the middle frame; and
three rear buttons fixedly mounted on the outer wall at one side of the middle frame in parallel.

4. The rubber injection mold according to claim 1, wherein a sidewall edge-tearing groove is formed on an outer wall joint of the bottom mold, adjoining the upper mold.

5. The rubber injection mold according to claim 1, wherein lower-mold-locking briquettings are respectively fixedly mounted at two ends of the bottom mold.

6. The rubber injection mold according to claim 1, wherein a tapered feeding hole is formed on an upper surface of the upper mold, and connected to the finished areas.
